(19) United States
(12) Patent Application Publication
(10) Pub. No.: US 2025/0108467 A1
(43) Pub. Date: Apr. 3, 2025

(54) SUCTIONING COVER FOR A CORE DRILL BIT HAVING A PRESSURE REGULATING VALVE, AND USE OF THE SUCTIONING COVER

(71) Applicant: Hilti Aktiengesellschaft, Schaan (LI)

(72) Inventors: Oliver OHLENDORF, Landsberg (DE); Matthaeus HOOP, Eschen (LI)

(21) Appl. No.: 18/894,862

(22) Filed: Sep. 24, 2024

(30) Foreign Application Priority Data
Sep. 29, 2023 (EP) 23200698.1

(51) Int. Cl. B23Q 11/00; B23B 35/00; B23B 51/04

(52) U.S. Cl. CPC B23Q 11/0046; B23B 35/00; B23B 51/042; B23B 2251/68; B23B 2270/30; B23B 2270/62

(57) ABSTRACT

A suctioning cover for a core drill bit of a core drilling device is attachable to a rear side of the core drill bit in order that material for suctioning can be suctioned out of an interior of the core drill bit. The suctioning cover has a valve for setting a pressure in the interior of the core drill bit. The pressure regulating valve allows automatic setting of the pressure in the interior of the core drill bit, such that work can be performed using the core drill bit in an optimum pressure range. Material for suctioning can thus be suctioned out of the interior of the core drill bit particularly effectively. The suctioning cover can be used in particular when performing dry drilling using the core drill bit. A method of operating the suctioning cover, wherein the valve for setting the pressure can be used to set a pressure in the interior of the core drill bit or in a cavity of the suctioning cover.

This claims priority to European Patent Application EP23200698.1, filed on Sep. 29, 2023, which is hereby incorporated by reference herein.

The present invention relates to a suctioning cover for a core drill bit of a core drilling device. The core drill bit has a front side and a rear side, wherein the front side faces towards a substrate to be machined and the rear side faces away from the substrate to be machined. The core drill bit can be connected via a tool fitting to the core drilling device.

### BACKGROUND OF THE INVENTION

In the field of power tools, core drilling devices are known that can be used in particular to cut substantially cylindrical drill cores out of a substrate that is to be machined. The substrate may for example consist of concrete, masonry or wood, wherein the core drilling device can be used to drill in a downward, that is to say vertical, spatial direction into a floor, in an upward, that is to say overhead, spatial direction into a ceiling, or in a forward, that is to say horizontal, spatial direction into a vertical wall. Water is commonly used as a flushing medium and coolant during the operation of conventional core drilling devices. The water may be provided for example via a water management system (WMS) and can cool the core drill bit, which can become hot owing to the friction when a core drilling operation is being performed. The supplied water can furthermore be used to flush the borehole. This means that dust or particles that could impede the progress of the drilling operation can be flushed out of the borehole by the cooling water. The borehole can thus be cleaned, such that it is subsequently available in a flushed state for further use.

### SUMMARY OF THE INVENTION

There are however working locations where it is sought to perform core drilling operations but where, for example, no water is available as coolant and flushing medium, or the use of water is not permitted. This may be the case in particular when performing drilling operations inside buildings that have particular hygiene requirements, such as hospitals or nursing or care homes.

An object of the present invention consists in specifying a technical solution for cleaning and optimally performing dry core drilling operations.

The present invention provides a suctioning cover (10) for a core drill bit (50) of a core drilling device, wherein the core drill bit (50) has a front side (52), which faces towards a substrate U to be machined, and a rear side (54), which faces away from the substrate U to be machined, wherein the core drill bit (50) is connectable via a tool fitting (56) to the core drilling device, characterized in that the suctioning cover (10) is attachable to the rear side (54) of the core drill bit (50) in order that material for suctioning can be suctioned out of an interior (58) of the core drill bit (50), wherein the suctioning cover (10) has a valve (12) for setting a pressure in the interior (58) of the core drill bit (50).

According to the invention, a suctioning cover for a core drill bit of a core drilling device is provided. The core drill bit has a front side and a rear side, wherein the front side faces towards a substrate to be machined and the rear side faces away from the substrate to be machined. The core drill bit can be connected via a tool fitting to the core drilling device. The suctioning cover is characterized by the fact that it is attachable to the rear side of the core drill bit in order that material for suctioning can be suctioned out of an interior of the core drill bit, wherein the suctioning cover has a valve for setting a pressure in the interior of the core drill bit. In the context of the invention, the valve for setting a pressure can preferably be referred to as pressure regulating valve. The pressure regulating valve is preferably configured to regulate or set the pressure in the interior of the core drill bit. The provision of the pressure regulating valve on the suctioning cover allows automatic setting of a pressure in the interior of the core drill bit, such that work can be performed using the core drill bit in an optimum pressure range. Material for suctioning can thus be suctioned out of the interior of the core drill bit particularly effectively. The suctioning cover can be used in particular when performing dry drilling using the core drill bit, where no coolant or flushing water is used.

The invention firstly makes it possible to provide a technical solution for cleaning the borehole when performing dry drilling, and the invention secondly makes it possible to provide an optimum operating or working pressure for performing the core drilling operation. A negative pressure prevails in the interior of the core drill bit whilst work is performed using the core drilling device. Said negative pressure firstly ensures that the core drill bit is held firmly against the substrate to be machined.

In the context of the invention, it is preferred that a high degree of throttling can give rise to high negative pressures or negative-pressure values in the core drill bit. In other words, an intense negative pressure can be generated in the interior of the core drill bit by way of intense throttling by the pressure regulating valve, wherein it has been found that it is thus advantageously possible to provide high pressing forces that make the work of the user of the core drilling device easier.

This is advantageous in particular if the substrate to be machined is a vertical wall. Secondly, the negative pressure in the interior of the core drill bit generates a suction flow with which material for suctioning such as dust, drill cuttings or particles can be suctioned out of the borehole. Thus, in the context of the present invention, the negative pressure and the associated suction flow advantageously replace the flushing water that is used in the case of wet drilling to flush the borehole and cool the core drill bit. Tests have shown that a certain degree of cooling of the core drill bit can surprisingly also be effected by the suction flow.

The pressure regulating valve is preferably configured to set the pressure in the interior of the core drill bit such that, firstly, particularly effective suctioning of the material for suctioning is made possible, and secondly, the core drill bit is held stably against the substrate to be machined. In particular, the invention makes it possible to avoid an excessively high contact pressure, which in the case of conventional core drilling devices can disadvantageously cause the work being performed using the device to be stopped on the basis of safety functions or settings. By setting an optimum working and operating pressure, with which the suctioning of material for suctioning can preferably also be optimized, it is possible in particular to leave behind a particularly clean borehole in which only little additional reworking is required for further use. In particular, the invention allows dry core drilling with active pressure control. The active pressure control can be achieved in particular through the provision of the pressure regulating valve.

The pressure regulating valve can advantageously also be used to assist in generating a contact pressure of the tool of the power tool. For example, through the preferably automatic setting of the pressure, it can be achieved that the user of the power tool does not have to impart the entire pressing force that is required to create the bore. The work performed using the core drilling device can thus be made considerably easier.

In the context of the invention, it is preferred that the suctioning cover has a cavity as an interior, wherein a fluidic connection exists between the cavity of the suctioning cover and the interior of the core drill bit. The core drill bit may, preferably also on its rear side, have at least one opening such that a fluidic connection is created between a cavity or interior of the suctioning cover. Pressure equalization between the interior of the core drill bit and the cavity or interior of the suctioning cover is possible through the at least one opening or the fluidic connection that is created by the at least one opening on the rear side of the core drill bit. A pressure that prevails in the cavity or interior of the suctioning cover can thus be transmitted into the interior of the core drill bit, such that substantially the same pressure prevails in the cavity and interior of the suctioning cover as in the interior of the core drill bit. By connecting a suction device, a negative pressure can be generated in the cavity or interior of the suctioning cover, which negative pressure can be transmitted into the interior of the core drill bit through the fluidic connection between the cavity or interior of the suctioning cover and the interior of the core drill bit. The transmission of the (negative) pressure is effected in particular by way of a pressure equalization between the two cavities, which pressure equalization is effected in particular through the at least one opening on the rear side of the core drill bit, which opening preferably opens into the cavity or interior of the suctioning cover.

In the context of the invention, it is preferred that a pressure regulating flow can be generated by the pressure regulating valve, which pressure regulating flow preferably flows through the pressure regulating valve. The pressure regulating valve preferably connects the surroundings of the core drill bit to the cavity and interior of the suctioning cover and, owing to the fluidic connection, also to the interior of the core drill bit. In other words, the pressure regulating flow can pass from the surroundings of the core drill bit into the interior of the core drill bit in order to effect a pressure equalization between the interior of the core drill bit, at one side, and the surroundings of the core drill bit and/or the cavity or interior of the suctioning cover, at the other side. The pressure regulating flow is preferably a flow of fluid and in particular a flow of air, with which, for example, a pressure equalization can be effected between the cavity and interior of the suctioning cover and the interior of the core drill bit.

In the context of the invention, it is preferred that the suctioning cover has seals for sealing off the suctioning cover with respect to the core drill bit. The core drill bit may have a wide front region, the diameter of which substantially corresponds to the diameter of the substantially cylindrical drill core. The rear side of said wide portion may be adjoined by a relatively thin shaft that connects the core drill bit to the tool fitting of the core drilling device. The suctioning cover may preferably have a substantially circular basic shape, the lower end of which can be arranged on the rear side of the core drill bit. A seal may be arranged along—all or part of—the circle of contact that forms, which seal seals off the cavity or interior of the suctioning cover with respect to the surroundings of the core drill bit. The suctioning cover may in particular be arranged centrally and uniformly around the relatively thin shaft of the core drill bit. A circle or circumference of contact is also formed between the suctioning cover and the core drill bit at this shaft of the core drill bit, along all or part of which circle or circumference of contact there may be a seal for sealing off the cavity or interior of the suctioning cover with respect to the surroundings of the core drill bit. Through the provision of the at least one seal on the suctioning cover, it can be ensured that the pressure in the cavity or interior of the suctioning cover is set by means of the pressure regulating valve, and that air does not undesirably enter the cavity or interior of the suctioning cover from the surroundings at some other location. The seal may preferably also be in the form of, or comprise, a rotary bearing arrangement.

In the context of the invention, it is preferred that the suctioning cover has a suctioning connector, by means of which the suctioning cover is connectable to a suction device. The suctioning cover may be connected by means of the suctioning connector to a suction device such as a vacuum cleaner. A negative pressure or a suction flow can be generated in a manner known per se by means of the suction device, wherein the negative pressure and/or the suction flow can be transmitted via a suction hose and the suctioning connector into the cavity or interior of the suctioning cover and onwards into the interior of the core drill bit. In particular, the suctioning connector allows a stable connection of the suctioning cover to the suction hose and the suction device, and a transmission of the negative pressure or of the suction flow from the suction device into the interior of the suctioning cover and/or of the core drill bit.

In the context of the invention, it is preferred that the valve for setting the pressure is a throttle valve. Using a throttle valve as a pressure regulating valve makes it possible in particular to provide a technically particularly simple, low-maintenance solution. The pressure regulating valve designed as a throttle valve may have an opening having a substantially constant flow cross section that can be—automatically or manually—increased or decreased in size as required. In the context of the invention, it is preferred that the pressure regulating valve has an operating element by means of which the flow cross section can be set. It is thus advantageously possible for the pressure regulating flow to be adapted by means of the pressure regulating valve and for the pressure in the cavity or interior of the suctioning cover and/or in the interior of the core drill bit to be set.

In the context of the invention, it is preferred that the valve for setting the pressure is a threshold-based valve. Such a threshold-based valve may for example have a valve disc or a ball with a spring, and open or close at a particular threshold value. In this way, the internal pressure in the core drill bit and/or in the cavity or interior of the suctioning cover can be controlled in accordance with the opening stroke of the valve. Threshold-based valves may also comprise elastic elements, snap-action elements or rubber diaphragms which, when a particular pressure threshold is overshot or undershot, can change their shape or their state and thus close or open up the path for a pressure regulating flow through the pressure regulating valve.

In the context of the invention, it is preferred that the valve for setting the pressure is a pressure controller. In the context of the present invention, a pressure controller can be used to set, and keep constant, the pressure level in the interior of the core drill bit and/or in the cavity or interior of the suctioning cover. Ambient air that enters flows at a primary or inlet pressure from the inlet of the pressure regulating valve, which is preferably designed as a pressure controller, to the valve seat. The primary or inlet pressure is preferably the pressure that prevails in the surroundings of the core drill bit. It may however preferably also be referred to in the context of the invention as “ambient pressure”. The pressure regulating valve, which is preferably designed as a pressure controller, is preferably configured to bring the ambient air to a desired secondary or outlet pressure as it flows through the valve, wherein, in the context of the present invention, the secondary or outlet pressure prevails in the interior of the core drill bit. The pressure controller may have a valve plunger and a valve bore, wherein the valve plunger is actuated in order to open the valve bore. The pressure controller may furthermore have a spring and a diaphragm, wherein a spring force on the diaphragm is higher than the opposing outlet pressure if the secondary pressure falls. The valve plunger is thus pushed further downward, causing the valve opening to be increased in size. It is thus advantageously possible for the secondary pressure to increase again, and for the pressure (=secondary pressure) to be set in the interior of the core drill bit.

The valve for setting the pressure may also be designed as a proportional pressure control valve. With such a proportional pressure control valve, the pressure in the interior of the core drill bit and/or in the cavity or interior of the suctioning cover can advantageously be set particularly precisely. Proportional pressure control valves can furthermore be used in a particularly wide pressure range.

In a second aspect, the invention relates to a use of the suctioning cover, wherein the valve for setting the pressure can be used to set a pressure in the interior of the core drill bit or in a cavity of the suctioning cover. The pressure that can be set in the interior of the core drill bit or in a cavity of the suctioning cover can preferably be set in stages, wherein the pressure can be set for example in accordance with a diameter of the bore or of the core drill bit. In the context of the invention, it is very particularly preferred that the pressure in the interior of the core drill bit or in the cavity of the suctioning cover can be varied in accordance with the bore diameter. In an alternative embodiment of the invention, the pressure may preferably also be settable in continuously variable fashion.

The definitions, technical effects and advantages introduced for the suctioning cover apply analogously to the use of the suctioning cover. In the context of the invention, it is preferred that the pressure regulating valve is used to equalize pressure between an ambient pressure and a secondary pressure in the interior of the core drill bit. It is preferably possible for a pressure regulating flow to pass through the pressure regulating valve, and thus for the pressure that prevails in the surroundings of the core drill bit (=ambient pressure) to be admitted into the cavity or interior of the suctioning cover, such that the pressure in the cavity of the suctioning cover adapts to the ambient pressure. Through the fluidic connection between the cavity of the suctioning cover and the interior of the core drill bit, the pressure from the cavity of the suctioning cover can be transmitted into the interior of the core drill bit, where said pressure ensures effective suctioning of the material for suctioning formed during the operation of the core drilling device, and causes the core drill bit to be held stably and securely against the substrate to be machined.

In the context of the invention, it is preferred that different negative pressures or negative-pressure values can be set for different core drill bit diameters. In the context of the invention, this preferably means that the negative pressure within the core drill bit can be set or selected in accordance with the diameter of the core drill bit. Optimum suctioning of the material for suctioning can thus advantageously be achieved.

### BRIEF DESCRIPTION OF THE DRAWINGS

Further advantages can be found in the following description of the FIGURE. The FIGURE, the description and the claims contain numerous features in combination. A person skilled in the art will expediently also consider the features individually and combine them to form sensible further combinations.

Identical and similar components are denoted by the same reference signs in the FIGURE,

in which:

FIG. 1 shows a view of a preferred embodiment of the suctioning cover.

### DETAILED DESCRIPTION

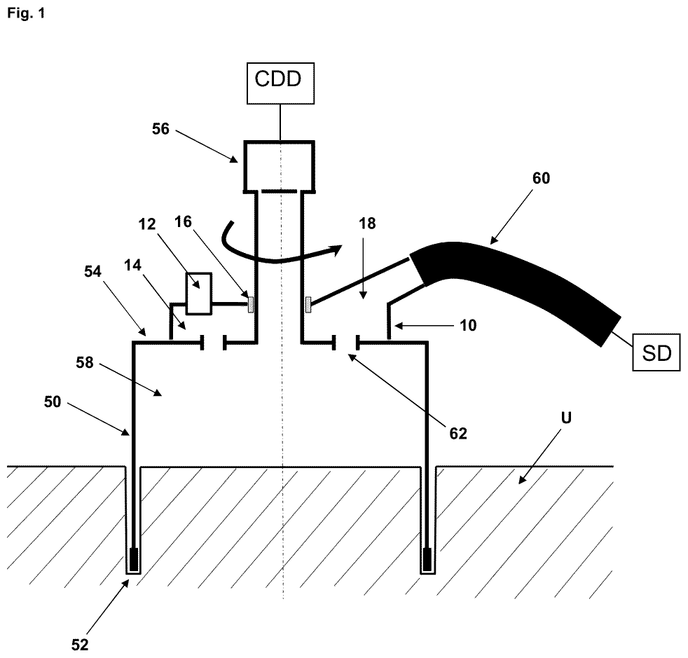

FIG. 1 shows a preferred embodiment of the suctioning cover 10. The suctioning cover 10 may be used in particular as an accessory when performing dry drilling using a core drilling device (not illustrated solely schematically as CDD). The core drilling device may have, as a tool, a core drill bit 50 that can be connected via a tool fitting 56 to the core drilling device. The curved arrow in FIG. 1 is intended to indicate the rotational movement in which the core drill bit 50 can be driven by the core drilling device. The core drill bit 50 may have a front side 52 and a rear side 54, wherein the front side 52 of the core drill bit 50 faces towards a substrate U to be machined and the rear side 54 of the core drill bit 50 faces away from the substrate U to be machined. At its inside, the core drill bit 50 has an interior 58 in which, during the operation of the core drilling device, the drill core that is cut out of the substrate U can be received. During the operation of the core drilling device, that is to say as the drill core is cut out of the substrate U, drill cuttings, dust and particles can form, which are preferably referred to in the context of the invention as material for suctioning. In the context of the present invention, said material for suctioning can be suctioned by means of a suction device (not illustrated solely schematically as SD). For this purpose, the suction device can be connected via a suction connector 18 to the suctioning cover 10. In the exemplary embodiment of the invention illustrated in FIG. 1, a suction hose 60 is arranged between the suctioning connector of the suctioning cover 10 and the suction device. The suction hose 60 is preferably part of the suction device.

The suctioning cover 10 has a valve 12 for setting a pressure, said valve preferably also being referred to in the context of the invention as “pressure regulating valve”. The pressure regulating valve 12 can be used to effect a pressure equalization between the ambient pressure around the core drill bit 50 and an interior 14 of the suctioning cover 10. The cavity or interior 14 of the suctioning cover 10 may be sealed off with respect to the core drill bit 50 and the surroundings by means of seals 16. The pressure regulating valve 12 may be designed as a throttle valve, threshold-based valve, pressure controller or proportional pressure control valve, without limitation to these. There is preferably a fluidic connection between the cavity or interior 14 of the suctioning cover 10 and the interior 58 of the core drill bit 50, which fluidic connection is formed by the at least one opening 62, which may be provided for example on the rear side 54 of the core drill bit 50. The opening 62 may for example be in the form of a hole or gap. If the at least one opening 62 is in the form of a hole, the rear side 54 of the core drill bit 50 may for example have a multiplicity of holes that allow an exchange of air or pressure equalization between the cavity or interior 14 of the suctioning cover 10 and the interior 58 of the core drill bit 50. If the at least one opening 62 is in the form of a gap, the rear side 54 of the core drill bit 50 may for example have an encircling gap that allows an exchange of air or pressure equalization between the cavity or interior 14 of the suctioning cover 10 and the interior 58 of the core drill bit 50. In the context of the invention, it is preferred that the encircling gap, which may form an opening 62 within the meaning of the invention, forms a circle, wherein a diameter of the circle is smaller than a diameter of the circle that forms the base surface of the suctioning cover 10. In other words, the suctioning cover 10 may have a substantially circular base surface that has a larger diameter than a gap that forms an opening 62 within the meaning of the invention. In this way, the gap or the opening 62 formed by said gap is situated preferably entirely in the cavity or interior 14 of the suctioning cover 10 and/or in the interior 58 of the core drill bit 50. The opening 62 between the cavity or interior 14 of the suctioning cover 10 and the interior 58 of the core drill bit 50 preferably forms the fluidic connection that allows the exchange of air or pressure equalization between the cavity or interior 14 of the suctioning cover 10 and the interior 58 of the core drill bit 50. The suctioning cover 10 may have a guide channel in the manner of a labyrinth seal in order to allow better guidance of the suctioning cover 10.

### LIST OF REFERENCE SIGNS

10 Suctioning cover
12 Pressure regulating valve
14 Cavity in the interior of the suctioning cover
16 Seal
18 Suctioning connector
50 Core drill bit
52 Front side of the core drill bit
54 Rear side of the core drill bit
56 Tool fitting
58 Interior of the core drill bit
60 Suction hose
62 Opening on the rear side of the core drill bit
U Substrate to be machined
CDD Core drilling device
SD Suction device

What is claimed is:

1. A suctioning cover for a core drill bit of a core drilling device, the core drill bit having a front side facing towards a substrate to be machined, and a rear side facing away from the substrate to be machined, the core drill bit connectable via a tool fitting to the core drilling device, the suctioning cover being attachable to the rear side of the core drill bit so that material for suctioning is suctionable out of an interior of the core drill bit, the suctioning cover comprising:
a valve for setting a pressure in the interior of the core drill bit.

2. The suctioning cover as recited in claim 1 further comprising a cavity as an interior, a fluidic connection existing between the cavity of the suctioning cover and the interior of the core drill bit.

3. The suctioning cover as recited in claim 2 further comprising a seal for sealing off the suctioning cover with respect to the core drill bit.

4. The suctioning cover as recited in claim 1 further comprising a suctioning connector for connection to a suction device.

5. The suctioning cover as recited in claim 1 wherein the valve is a throttle valve.

6. The suctioning cover as recited in claim 1 wherein the valve is a threshold-based valve.

7. The suctioning cover as recited in claim 1 wherein the valve is a pressure controller.

8. The suctioning cover as recited in claim 1 wherein the valve is a proportional pressure control valve.

9. A method for operating the suctioning cover as recited in claim 1 comprising:
setting, via the valve, a pressure in the interior of the core drill bit or in a cavity of the suctioning cover.

10. The method as recited in claim 9 wherein the valve is used to equalize pressure between an ambient pressure and a secondary pressure in the interior of the core drill bit.
